(19) United States
(12) Patent Application Publication
(10) Pub. No.: US 2025/0355299 A1
(43) Pub. Date: Nov. 20, 2025

(54) DISPLAY DEVICE

(71) Applicant: Japan Display Inc., Tokyo (JP)

(72) Inventors: Kasumi HASE, Tokyo (JP); Kentaro OKUYAMA, Tokyo (JP)

(21) Appl. No.: 19/192,546

(22) Filed: Apr. 29, 2025

(30) Foreign Application Priority Data
May 15, 2024 (JP) 2024-079460

(51) Int. Cl. G02F 1/1337; G02F 1/1333; G02F 1/1334; G02F 1/13357; G02F 1/137

(52) U.S. Cl. CPC G02F 1/1337; G02F 1/133331; G02F 1/1334; G02F 1/133615; G02F 1/13712; G02F 1/13725

(57) ABSTRACT

According to one embodiment, a display device includes a display panel including a polymer dispersed liquid crystal containing a polymer and a liquid crystal molecule in a display area which displays an image, a light source unit provided along an edge portion of the display panel, a glass member located on a side opposite to an observation position of the display panel, and a dimming panel located between the display panel and the glass member and having a guest-host liquid crystal in a dimming area which overlaps the display area. An initial alignment direction of the liquid crystal molecule in the display panel is parallel to an absorption axis in the dimming panel.

### CROSS-REFERENCE TO RELATED APPLICATIONS

This application is based upon and claims the benefit of priority from Japanese Patent Application No. 2024-079460, filed May 15, 2024, the entire contents of which are incorporated herein by reference.

### FIELD

Embodiments described herein relate generally to a display device.

### BACKGROUND

Various types of display devices using polymer dispersed liquid crystals which can switch between a scattered state for scattering incident light and a transparent state for transmitting incident light have been suggested. In display devices using polymer dispersed liquid crystals, an edge light method, in which a light emitting module is provided in an end portion of a display panel, is used in some cases. Since such display devices have a high transmittance, the use in various fields is expected.

### BRIEF DESCRIPTION OF THE DRAWINGS

FIG. 1 is a diagram showing a configuration example of a display device 1.

FIG. 2 is a diagram showing a configuration example of the display panel 100 shown in FIG. 1.

FIG. 3 is a cross-sectional view schematically showing a configuration example of the display panel 100 shown in FIG. 2.

FIG. 4 is a diagram showing a configuration example of the dimming panel 300 shown in FIG. 1.

FIG. 5 is a cross-sectional view schematically showing a configuration example of the dimming panel 300 shown in FIG. 4.

FIG. 6A is a diagram for explaining the effect of the dimming panel 300 in an off state.

FIG. 6B is a diagram for explaining the effect of the dimming panel 300 in an on state.

FIG. 7A is a diagram for explaining the effect of the dimming panel 300 in an off state.

FIG. 7B is a diagram for explaining the effect of the dimming panel 300 in an on state.

FIG. 8A is a diagram showing the measurement result of experiment 1.

FIG. 8B is a diagram showing the measurement result of experiment 2.

FIG. 9 is a diagram for explaining the matrix driving of the dimming panel 300.

FIG. 10 is a diagram for explaining application example 1.

FIG. 11 is a diagram for explaining application example 2.

FIG. 12 is a diagram for explaining application example 3.

FIG. 13 is a diagram for explaining application example 4.

FIG. 14 is a diagram for explaining a configuration example of the control system of the display device 1.

FIG. 15 is a diagram for explaining an example of the control of a vertical alignment dimming panel 300.

FIG. 16 is a diagram for explaining an example of the control of a horizontal alignment dimming panel 300.

### DETAILED DESCRIPTION

In general, according to one embodiment, a display device comprises a display panel comprising a polymer dispersed liquid crystal containing a polymer and a liquid crystal molecule in a display area which displays an image, a light source unit provided along an edge portion of the display panel, a glass member located on a side opposite to an observation position of the display panel, and a dimming panel located between the display panel and the glass member and comprising a guest-host liquid crystal in a dimming area which overlaps the display area. An initial alignment direction of the liquid crystal molecule in the display panel is parallel to an absorption axis in the dimming panel.

Embodiments will be described with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the drawings, in order to facilitate understanding, an X-axis, a Y-axis and a Z-axis orthogonal to each other are shown depending on the need. A direction parallel to the X-axis is referred to as a first direction X. A direction parallel to the Y-axis is referred to as a second direction Y. A direction parallel to the Z-axis is referred to as a third direction Z. When various elements are viewed parallel to the third direction Z, the appearance is defined as a plan view. When terms indicating the positional relationships of two or more structural elements, such as “on”, “above” “between” and “face”, are used, the target structural elements may be directly in contact with each other or may be spaced apart from each other as a gap or another structural element is interposed between them. The positive direction of the Z-axis is referred to as “on” or “above”.

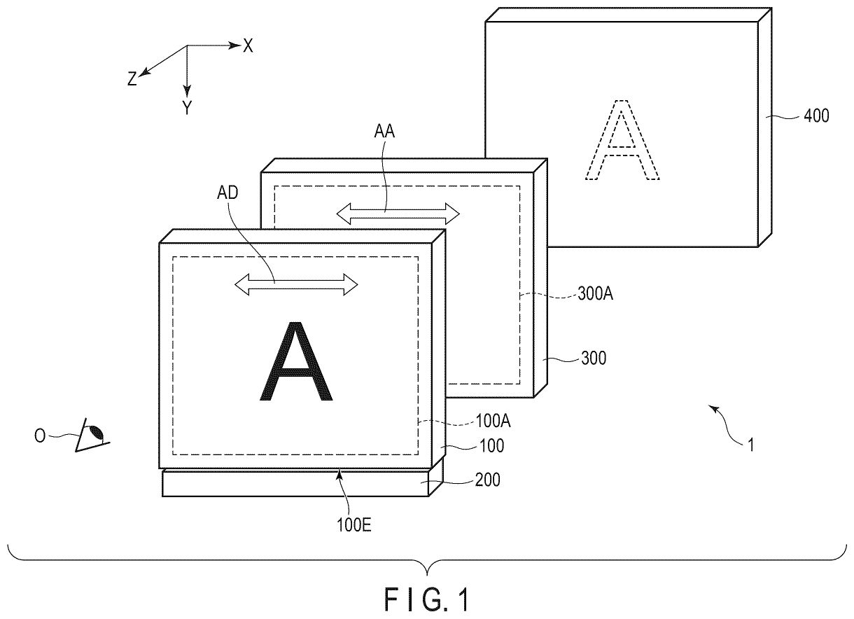

FIG. 1 is a diagram showing a configuration example of a display device 1.

The display device 1 comprises a display panel 100 configured to display images, a light source unit 200 configured to illuminate the display panel 100, a dimming panel 300 configured to dim display light emitted from the display panel 100, and a glass member (back plate) 400 located on the back side of the display panel 100.

The display panel 100 comprises a polymer dispersed liquid crystal in a display area 100A which displays images. As described later, the polymer dispersed liquid crystal has polymers and liquid crystal molecules. In the example shown in the figure, the initial alignment direction AD of the liquid crystal molecules is set so as to be a first direction X. The initial alignment direction AD corresponds to the alignment direction of the liquid crystal molecules in an off state where no voltage is applied to the liquid crystal molecules. In the example shown in the figure, in an X-Y plane defined by the first direction X and a second direction Y, the liquid crystal molecules in an off state are aligned such that their long axes are parallel to the first direction X. The polymers extend in the first direction X.

The light source unit 200 is provided along an edge portion 100E of the display panel 100. In the example shown in the figure, the edge portion 100E extends in the first direction X. Illumination light emitted from the light source unit 200 is made incident on the edge portion 100E, and thus, the display area 100A is illuminated with the illumination light.

The dimming panel 300 comprises a guest-host liquid crystal in a dimming area 300A which overlaps the display area 100A in a third direction Z. As described later, the guest-host liquid crystal has dichroic dye molecules as guest molecules, and liquid crystal molecules as host molecules.

The absorbance of guest molecules differs between the long axis direction and the short axis direction. The guest molecules mainly absorb a linearly polarized light component parallel to the long axis direction. For this reason, the dimming area 300A can be colored based on the color of the guest molecules. When the guest molecules are black dichroic dye molecules, the guest molecules can absorb a linearly polarized light component parallel to the long axis and form a light-shielding area in the dimming area 300A. The long axis direction of these guest molecules corresponds to the absorption axis AA in the dimming panel 300. The absorption axis AA is parallel to the initial alignment direction AD, and in the example shown in the figure, is set so as to be the first direction X.

The glass member 400 is located on a side opposite to the observation position O of the display panel 100. The dimming panel 300 is located between the display panel 100 and the glass member 400.

Here, this specification explains a case where the letter “A” is displayed in the display area 100A as shown in the figure. The display light emitted from the display panel 100 is mainly linearly polarized light parallel to the first direction X. Since the display light which proceeds from the display panel 100 toward the glass member 400 is linearly polarized light parallel to the absorption axis AA of the dimming panel 300, the display light is absorbed in the dimming panel 300. In this manner, the display light hardly reaches the glass member 400.

Thus, when an image is displayed on the display panel 100, undesired reflection in the glass member 400 can be prevented. In other words, the generation of ghost images on the back side of the display panel 100 is prevented, and thus, the display quality of images observed at the observation position O can be improved.

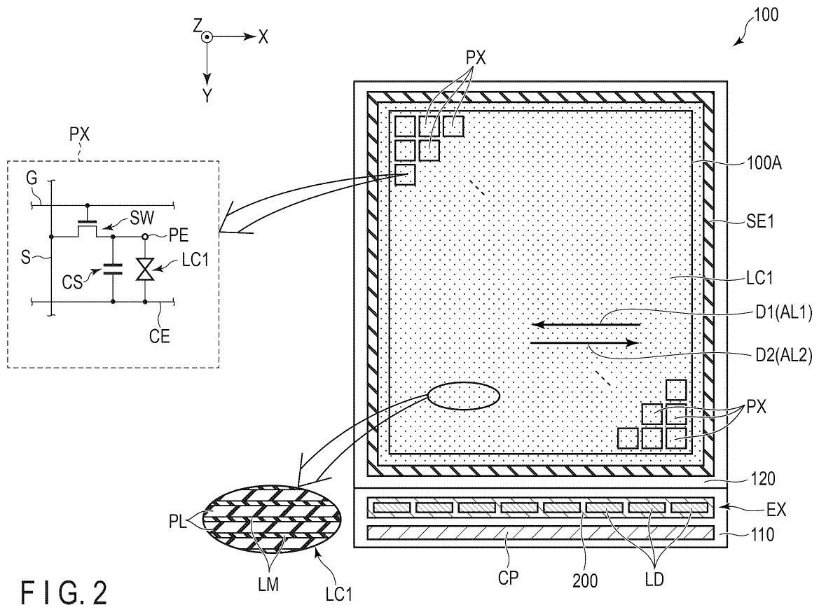

FIG. 2 is a diagram showing a configuration example of the display panel 100 shown in FIG. 1.

The display panel 100 comprises a transparent substrate 110, a transparent substrate 120, a liquid crystal layer LC1 and a sealing member SE1. Each of the transparent substrate 110 and the transparent substrate 120 is formed into a plate-like shape parallel to an X-Y plane. The transparent substrate 110 and the transparent substrate 120 overlap each other as seen in plan view. The transparent substrate 110 is extended in the second direction Y further compared to the transparent substrate 120. In the example shown in the figure, each of the transparent 110 and the transparent substrate 120 is formed into a rectangle. However, the shapes are not limited to this example. For example, each of the transparent substrate 110 and the transparent substrate 120 may have any shape such as a polygon different from a rectangle, a circle, an oval or a semicircle.

The liquid crystal layer LC1 is located between the transparent substrate 110 and the transparent substrate 120 and sealed with the sealing member SE1. The alignment treatment direction D1 of an alignment film AL1 located between the transparent substrate 110 and the liquid crystal layer LC1 and the alignment treatment direction D2 of an alignment film AL2 located between the transparent substrate 120 and the liquid crystal layer LC1 are parallel to each other and opposite directions. In the example shown in the figure, both the alignment treatment direction D1 and the alignment treatment direction D2 are parallel to the first direction X. It should be noted that the alignment treatment applied to each of the alignment film AL1 and the alignment film AL2 may be rubbing treatment or may be photo-alignment treatment.

As schematically shown in an enlarged view of the figure, the liquid crystal layer LC1 comprises a polymer dispersed liquid crystal containing polymers PL and liquid crystal molecules LM. For example, the polymers PL are liquid crystalline polymers. Each of the polymers PL and the liquid crystal molecules LM has optical anisotropy or refractive anisotropy. The responsiveness of the polymers PL for an electric field is lower than that of the liquid crystal molecules LM for an electric field.

Since the alignment treatment direction D1 and the alignment treatment direction D2 are parallel to the first direction X as described above, the polymers PL are formed into a streaky shape which extends in the first direction X. The liquid crystal molecules LM are dispersed in the gaps of the polymers PL, and are aligned such that their long axes are parallel to the first direction X. Thus, as shown in FIG. 1, the initial alignment direction AD of the liquid crystal molecules LM is set so as to be the first direction X.

The alignment direction of the polymers PL does not substantially change regardless of the presence or absence of an electric field. To the contrary, the alignment direction of the liquid crystal molecules LM changes based on the electric field in a state where a high voltage greater than or equal to a threshold is applied to the liquid crystal layer LC1. In a state where no voltage is applied to the liquid crystal layer LC1, the optical axes of the polymers PL are parallel to those of the liquid crystal molecule LM, and the light which entered the liquid crystal layer LC1 is not substantially scattered inside the liquid crystal layer LC1 and passes through the liquid crystal layer LC1 (transparent state). In a state where voltage is applied to the liquid crystal layer LC1, the optical axes of the polymers PL intersect with those of the liquid crystal molecules LM, and the light which entered the liquid crystal layer LC1 is scattered inside the liquid crystal layer LC1 (scattered state).

It should be noted that the configuration of the polymer dispersed liquid crystal containing the polymers PL and the liquid crystal molecules LM is not limited to the example described above.

The display area 100A comprises a plurality of pixels PX arrayed in matrix in the first direction X and the second direction Y.

As shown in an enlarged view of the figure, each pixel PX comprises a switching element SW, a pixel electrode PE, a common electrode CE, the liquid crystal layer LC1, etc. The switching element SW consists of, for example, a thin-film transistor (TFT), and is electrically connected to a scanning line G and a signal line S.

The scanning line G extends in the first direction X, and is electrically connected to the switching element SW in each of pixels PX arranged in the first direction X. In other words, both the alignment treatment direction D1 and the alignment treatment direction D2 are parallel to the scanning line G. The streaky polymers PL extend parallel to the scanning line G.

The signal line S extends in the second direction Y, intersects with the scanning line G and is electrically connected to the switching element SW in each of pixels PX arranged in the second direction Y. In other words, the alignment treatment direction D1 and the alignment treatment direction D2 intersect with or are orthogonal to the signal line S. The streaky polymers PL extend so as to intersect with the signal line S.

The pixel electrode PE is electrically connected to the switching element SW. Each pixel electrode PE faces the common electrode CE, and drives the liquid crystal layer LC1 (in particular, liquid crystal molecules LM) by the electric field generated between the pixel electrode PE and the common electrode CE. For example, capacitance CS is formed between an electrode having the same potential as the common electrode CE and an electrode having the same potential as the pixel electrode PE.

The scanning line G, the signal line S, the switching element SW and the pixel electrode PE are formed between the transparent substrate 110 and the liquid crystal layer LC1. The common electrode CE is formed between the transparent substrate 120 and the liquid crystal layer LC1.

An IC chip CP and a flexible printed circuit (not shown) are mounted on the transparent substrate 110.

The light source unit 200 is configured to emit illumination light with which the liquid crystal layer LC1 is illuminated. The light source unit 200 comprises a plurality of light emitting elements LD arranged at intervals in the first direction X.

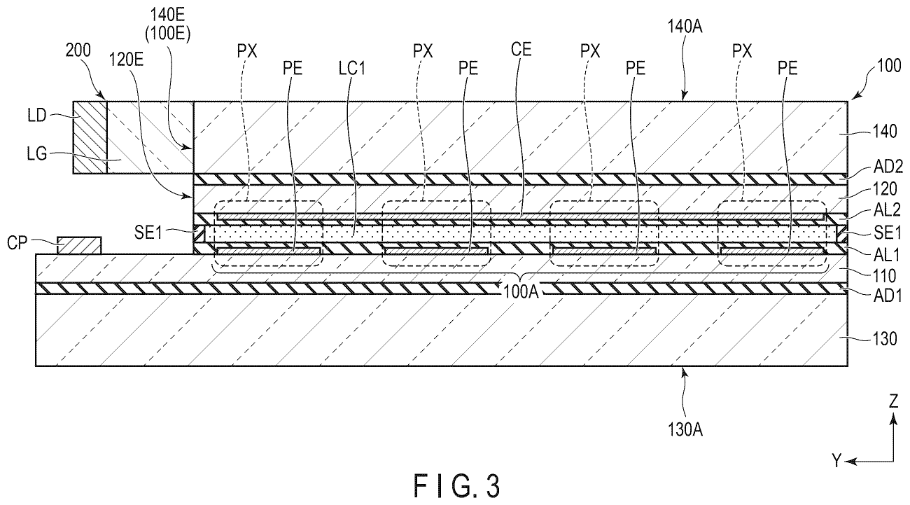

FIG. 3 is a cross-sectional view schematically showing a configuration example of the display panel 100 shown in FIG. 2.

In the display panel 100, the illustrations of the scanning line, signal line, switching element, insulating films, etc., described above are omitted.

The transparent substrate 110 and the transparent substrate 120 face each other in the third direction Z. The liquid crystal layer LC1 is located between the transparent substrate 110 and the transparent substrate 120. The pixel electrode PE of each pixel PX is located between the transparent substrate 110 and the liquid crystal layer LC1 and is covered with the alignment film AL1. The common electrode CE facing the pixel electrodes PE is located between the transparent substrate 120 and the liquid crystal layer LC1 and is covered with the alignment film AL2. The liquid crystal layer LC1 is in contact with the alignment film AL1 and the alignment film AL2. Each of the pixel electrodes PE and the common electrode CE is, for example, a transparent electrode formed of a transparent conductive material such as indium tin oxide (ITO).

In the example shown in the figure, the display panel 100 further comprises a transparent substrate 130 and a transparent substrate 140. The transparent substrate 130 is attached to the transparent substrate 110 via a transparent adhesive layer AD1. The transparent substrate 140 is attached to the transparent substrate 120 via a transparent adhesive layer AD2. The side surface 120E of the transparent substrate 120 and the side surface 140E of the transparent substrate 140 overlap each other in the third direction Z. For example, the side surface 140E corresponds to the edge portion 100E of the display panel 100 shown in FIG. 1. In the example shown in the figure, each of the main surface 130A of the transparent substrate 130 and the main surface 140A of the transparent substrate 140 is parallel to an X-Y plane and is in contact with air.

Each of the adhesive layer AD1 and the adhesive layer AD2 has a refractive index which is substantially equal to the refractive indices of the transparent substrate 110, the transparent substrate 120, the transparent substrate 130 and the transparent substrate 140. For this reason, undesired interface reflection is prevented between the transparent substrate 110 and the transparent substrate 130 and between the transparent substrate 120 and the transparent substrate 140.

The light source unit 200 faces the side surface 140E of the transparent substrate 140 in the second direction Y. It should be noted that the light source unit 200 may face both the side surface 120E and the side surface 140E. The light source unit 200 comprises a light emitting element LD and a light guide LG. Although not described in detail, the light emitting element LD comprises a red light emitting unit, a green light emitting unit and a blue light emitting unit. These red light emitting unit, green light emitting unit and blue light emitting unit may light up in series, or all of them may light up at the same time. The light guide LG is located between the light emitting element LD and the transparent substrate 140 in the second direction Y.

Each of the transparent substrate 110, the transparent substrate 120, the transparent substrate 130 and the transparent substrate 140 is, for example, a glass substrate. However, each of them may be a resinous substrate. Each of the transparent substrate 130 and the transparent substrate 140 functions as a cover member. The transparent substrate 140 functions as a light guide which transmits the light emitted from the light source unit 200 in the second direction Y.

For example, the transparent substrate 130 is thicker than the transparent substrate 110, and the transparent substrate 140 is thicker than the transparent substrate 120. It should be noted that the transparent substrate 130 and the transparent substrate 140 may be omitted. When the transparent substrate 140 is omitted, the light source unit 200 is provided so as to face the side surface 120E of the transparent substrate 120 in the second direction Y.

In this display panel 100, when voltage is applied to each pixel PX, light emitted from the light source unit 200 is scattered in the liquid crystal layer LC1 of each pixel PX and becomes display light, and thus, an image is displayed in the display area 100A. The display light emitted from the display panel 100 is linearly polarized light parallel to the first direction X.

In a case where the liquid crystal layer LC1 is in a transparent state, when the display panel 100 is observed from the main surface 130A side, the background can be observed through the display panel 100, and similarly, when the display panel 100 is observed from the main surface 140A side, the background can be observed through the display panel 100.

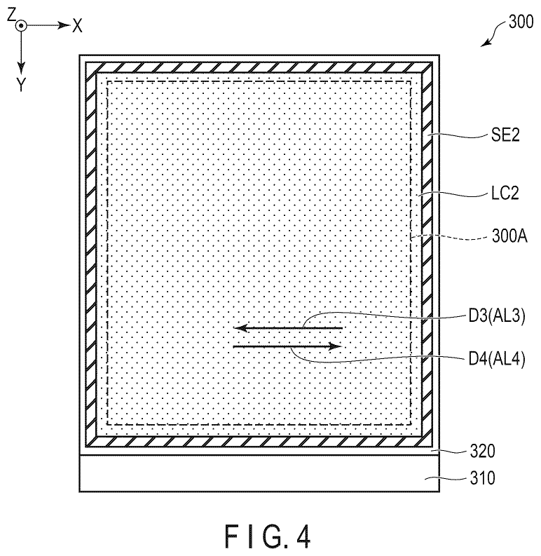

FIG. 4 is a diagram showing a configuration example of the dimming panel 300 shown in FIG. 1.

The dimming panel 300 comprises a transparent substrate 310, a transparent substrate 320, a liquid crystal layer LC2 and a sealing member SE2. Each of the transparent substrate 310 and the transparent substrate 320 is formed into a plate-like shape parallel to an X-Y plane, and they overlap each other as seen in plan view. In the example shown in the figure, each of the transparent 310 and the transparent substrate 320 is formed into a rectangle. However, the shapes are not limited to this example. For example, each of the transparent substrate 310 and the transparent substrate 320 may have any shape such as a polygon different from a rectangle, a circle, an oval or a semicircle.

The liquid crystal layer LC2 is located between the transparent substrate 310 and the transparent substrate 320 and sealed with the sealing member SE2. The alignment treatment direction D3 of an alignment film AL3 located between the transparent substrate 310 and the liquid crystal layer LC2 and the alignment treatment direction D4 of an alignment film AL4 located between the transparent substrate 320 and the liquid crystal layer LC2 are parallel to each other and opposite directions. Further, the alignment treatment direction D3 and the alignment treatment direction D4 are parallel to the alignment treatment direction D1 and alignment treatment direction D2 explained with reference to FIG. 2. In the example shown in the figure, both the alignment treatment direction D3 and the alignment treatment direction D4 are parallel to the first direction X. It should be noted that the alignment treatment applied to each of the alignment film AL3 and the alignment film AL4 may be rubbing treatment or may be photo-alignment treatment.

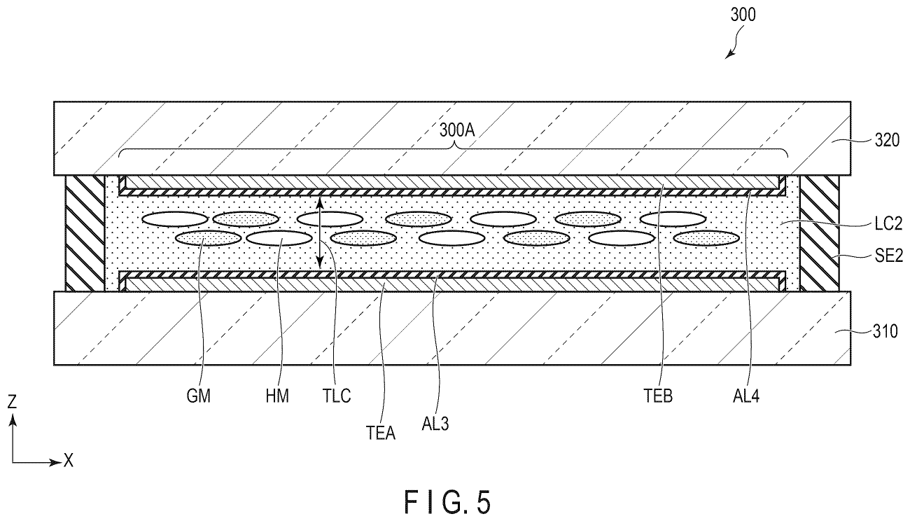

FIG. 5 is a cross-sectional view schematically showing a configuration example of the dimming panel 300 shown in FIG. 4.

The transparent substrate 310 and the transparent substrate 320 face each other in the third direction Z. The liquid crystal layer LC2 is located between the transparent substrate 310 and the transparent substrate 320. In the dimming area 300A, a transparent electrode TEA is located between the transparent substrate 310 and the liquid crystal layer LC2 and is covered with the alignment film AL3. A transparent electrode TEB is located between the transparent substrate 320 and the liquid crystal layer LC2 and is covered with the alignment film AL4. The liquid crystal layer LC2 is in contact with the alignment film AL3 and the alignment film AL4.

Each of the transparent substrate 310 and the transparent substrate 320 is, for example, a glass substrate. However, each of them may be a resinous substrate.

Each of the transparent electrode TEA and the transparent electrode TEB is formed of, for example, a transparent conductive material such as indium tin oxide (ITO). The transparent electrode TEA and the transparent electrode TEB are, for example, sheet electrodes provided over the dimming area 300A.

It should be noted that each of the transparent electrode TEA and the transparent electrode TEB may be a plurality of strip electrodes. In this case, the first strip electrode corresponding to the transparent electrode TEA and the second strip electrode corresponding to the transparent electrode TEB are provided so as to intersect each other in the dimming area 300A. The intersection of the first and second strip electrodes constitutes a segment of the dimming area 300A. The liquid crystal layer LC2 of the segment is driven based on the potential difference between the first strip electrode and the second strip electrode (passive matrix driving).

The transparent electrode TEA may be a plurality of segment electrodes arranged in matrix, and the transparent electrode TEB may be a sheet electrode provided over the dimming area 300A. In this case, each of the segment electrodes is electrically connected to an active element. In an area where one segment electrode faces the sheet electrode constitutes a segment of the dimming area 300A. The liquid crystal layer LC2 of the segment is driven based on the potential difference between the segment electrode and the sheet electrode (active matrix driving).

The liquid crystal layer LC2 comprises a guest-host liquid crystal containing dichroic dye molecules as guest molecules GM and liquid crystal molecules as host molecules HM. For example, the guest molecules GM are black dichroic dye molecules. The example of the figure shows a state where each of the guest molecules GM and the host molecules HM is aligned in the first direction X. Thickness TLC of the liquid crystal layer LC2 between the alignment film AL3 and the alignment film AL4 in the third direction Z is, for example, greater than or equal to 5 μm and less than or equal to 20 μm, and should be preferably 10 μm+2 μm.

Now, this specification explains a vertical alignment dimming panel 300.

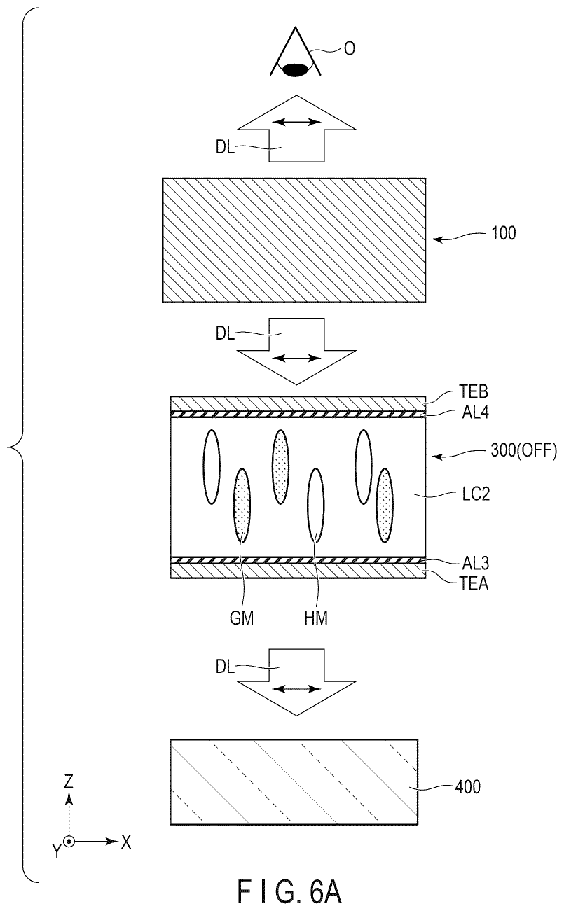

FIG. 6A is a diagram for explaining the effect of the dimming panel 300 in an off state. Here, the figure shows only configurations necessary for explanation. The illustration of the other configurations is simplified or omitted.

In the dimming panel 300, each of the alignment film AL3 which covers the transparent electrode TEA and the alignment film AL4 which covers the transparent electrode TEB is a vertical alignment film and has an alignment restriction force in its normal direction (in other words, the third direction Z). It should be noted that, as explained with reference to FIG. 4, alignment treatment has been applied to the alignment film AL3 and the alignment film AL4. The host molecules HM are liquid crystal molecules having a negative dielectric anisotropy. The guest molecules GM are black dichroic dye molecules.

In an off state (OFF), no potential difference is formed between the transparent electrode TEA and the transparent electrode TEB. Therefore, voltage is not applied to the liquid crystal layer LC2. At this time, the host molecules HM are initially aligned such that their long axes are parallel to the third direction Z by the alignment restriction force of the alignment film AL3 and the alignment film AL4. In a manner similar to that of the host molecules HM, the guest molecules GM are aligned such that their long axes are parallel to the third direction Z. Thus, both the host molecules HM and the guest molecules GM are vertically aligned. Therefore, no absorption axis is formed in the dimming panel 300.

In a case where the display panel 100 is in a transparent state, at the observation position o, the glass member 400 can be observed through the display panel 100 and the dimming panel 300, and further, the background of the glass member 400 can be observed.

In a case where the display panel 100 is in a scattered state, and an image is displayed, display light DL is emitted toward the observation position O and is emitted toward the dimming panel 300. Display light DL is linearly polarized light parallel to the first direction X as described above. At the observation position O, the image of the display panel 100 is observed. Display light DL which proceeds to the dimming panel 300 passes through the dimming panel 300 with little absorption in the dimming panel 300 and reaches the glass member 400.

In a place where the surrounding area of the display device is relatively dark, display light DL reflected on the glass member 400 is easily recognized and could become a ghost image. In the meantime, in a place where the surrounding area of the display device is relatively bright, display light DL reflected on the glass member 400 is not easily recognized. For this reason, at the observation position O, the image of the display panel 100 is observed, and the glass member 400 can be observed through the display panel 100 and the dimming panel 300, and further, the background of the glass member 400 can be observed.

FIG. 6B is a diagram for explaining the effect of the dimming panel 300 in an on state.

In an on state (ON), a potential difference is formed between the transparent electrode TEA and the transparent electrode TEB. Therefore, voltage is applied to the liquid crystal layer LC2. At this time, the host molecules HM are aligned so as to intersect with the electric field formed in the liquid crystal layer LC2. As described above, since alignment treatment has been applied to the alignment film AL3 and the alignment film AL4 such that the alignment treatment directions are parallel to the first direction X, the host molecules HM are aligned such that their long axes are parallel to the first direction X. The guest molecules GM follow the host molecules HM and are aligned such that their long axes are parallel to the first direction X. Thus, both the host molecules HM and the guest molecules GM are horizontally aligned. By this configuration, the absorption axis AA parallel to the first direction X is formed in the dimming panel 300.

In a case where the display panel 100 is in a transparent state, at the observation position O, the glass member 400 can be observed through the display panel 100 and the dimming panel 300, and further, the background of the glass member 400 can be observed. It should be noted that, as a polarization component parallel to the first direction X is absorbed in the dimming panel 300, the transmittance is decreased compared to the dimming panel 300 which is in an off state.

In a case where the display panel 100 is in a scattered state, and an image is displayed, the image of the display panel 100 is observed at the observation position O. Display light DL which proceeds to the dimming panel 300 is mostly absorbed in the dimming panel 300. For this reason, the reflection of display light DL on the glass member 400 is prevented. Thus, regardless of whether the place is dark or bright, the generation of ghost images is prevented, and the visibility of the image of the display panel 100 can be improved.

Now, a horizontal alignment dimming panel 300 is explained.

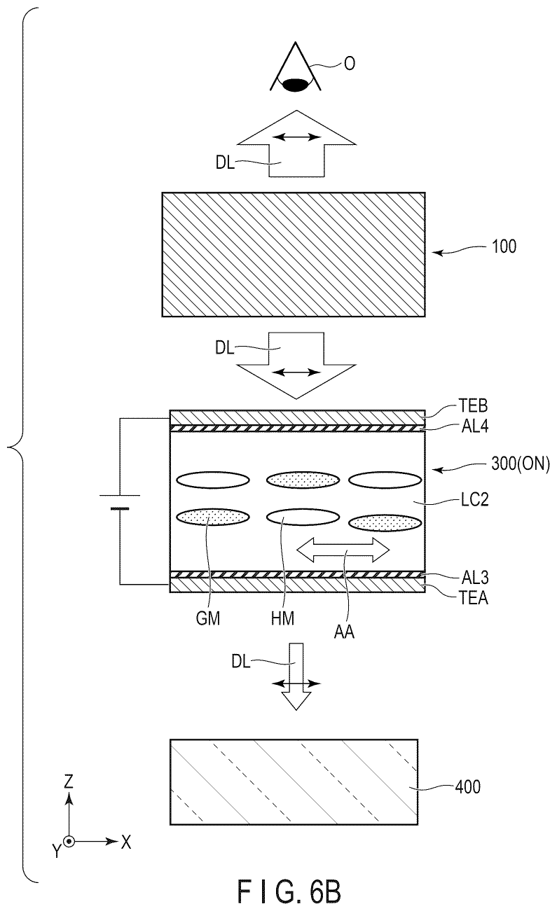

FIG. 7A is a diagram for explaining the effect of the dimming panel 300 in an off state. Here, the figure shows only configurations necessary for explanation. The illustration of the other configurations is simplified or omitted.

In the dimming panel 300, each of the alignment film AL3 which covers the transparent electrode TEA and the alignment film AL4 which covers the transparent electrode TEB is a horizontal alignment film and has an alignment restriction force in the first direction X. The host molecules HM are liquid crystal molecules having a positive dielectric anisotropy. The guest molecules GM are black dichroic dye molecules.

In an off state (OFF), no potential difference is formed between the transparent electrode TEA and the transparent electrode TEB. Therefore, voltage is not applied to the liquid crystal layer LC2. At this time, the host molecules HM are initially aligned such that their long axes are parallel to the first direction X by the alignment restriction force of the alignment film AL3 and the alignment film AL4. In a manner similar to that of the host molecules HM, the guest molecules GM are aligned such that their long axes are parallel to the first direction X. Thus, both the host molecules HM and the guest molecules GM are horizontally aligned. By this configuration, the absorption axis AA parallel to the first direction X is formed in the dimming panel 300.

In the off-state of the horizontal alignment dimming panel 300 as described above, effects similar to those of the on-state of the vertical alignment dimming panel 300 explained with reference to FIG. 6B are obtained.

FIG. 7B is a diagram for explaining the effect of the dimming panel 300 in an on state.

In an on state (ON), a potential difference is formed between the transparent electrode TEA and the transparent electrode TEB. Therefore, voltage is applied to the liquid crystal layer LC2. At this time, the host molecules HM are aligned so as to be parallel to the electric field formed in the liquid crystal layer LC2. In other words, the host molecules HM are aligned such that their long axes are parallel to the third direction Z. The guest molecules GM follow the host molecules HM and are aligned such that their long axes are parallel to the third direction Z. Thus, both the host molecules HM and the guest molecules GM are vertically aligned. Therefore, no absorption axis is formed in the dimming panel 300.

In the on-state of the horizontal alignment dimming panel 300 as described above, effects similar to those of the off-state of the vertical alignment dimming panel 300 explained with reference to FIG. 6A are obtained.

Now, this specification explains the optical properties of the dimming panel 300. Here, an experiment in which the transmittance is measured regarding a vertical alignment dimming panel 300 was conducted.

The experimental conditions are as follows. Under an environment of 25° C., a light source, a polarizer, a dimming panel and a detector are provided in this order. The light source is configured to emit non-polarized illumination light. In a state where the light source lights up, the transmitted light of the dimming panel is detected by the detector and the transmittance is measured while changing the voltage applied to the liquid crystal layer of the dimming panel.

In experiment 1, the transmittance was measured on the condition that the alignment treatment direction D3 and the alignment treatment direction D4 are parallel to the absorption axis of the polarizer.

In experiment 2, the transmittance was measured on the condition that the alignment treatment direction D3 and the alignment treatment direction D4 are orthogonal to the absorption axis of the polarizer. In experiment 1 and experiment 2, the transmittance was measured regarding cases where the thickness TLC of the liquid crystal layer LC2 is 5 μm, 10 μm and 20 μm.

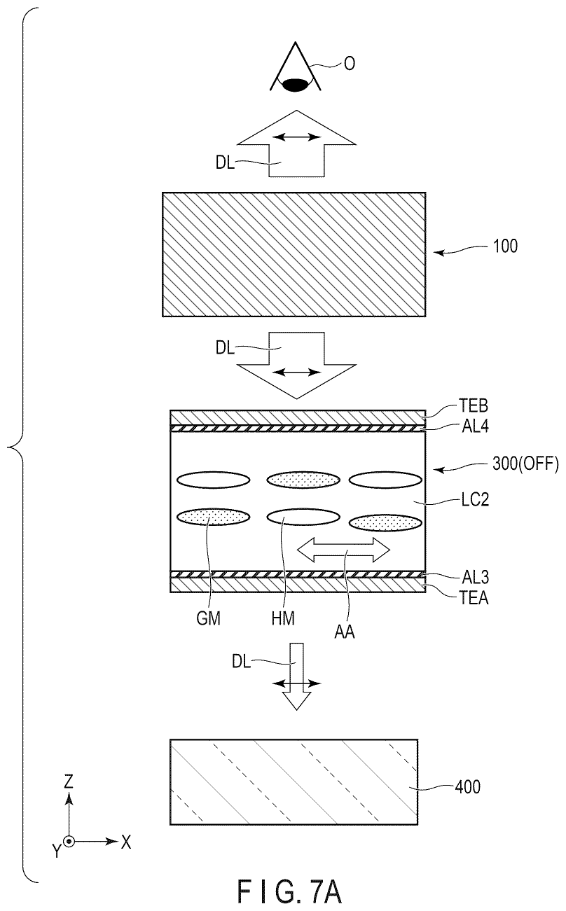

FIG. 8A is a diagram showing the measurement result of experiment 1.

FIG. 8B is a diagram showing the measurement result of experiment 2.

In FIG. 8A and FIG. 8B, the horizontal axis indicates the applied voltage E (V) of the liquid crystal layer, and the vertical axis indicates the transmittance T (%).

As shown in FIG. 8A, according to experiment 1, the transmittance T is almost constant regardless of the applied voltage E. Thus, it was confirmed that the absorption axis of the dimming panel formed at the time of the application of voltage to the liquid crystal layer LC2 was parallel to the absorption axis of the polarizer.

As shown in FIG. 8B, according to experiment 2, the transmittance T is decreased in association with the increase in the applied voltage E. In a case where the thickness TLC is 5 μm, the transmittance T is less than or equal to 10% when a voltage greater than or equal to 5 V is applied. In a case where the thickness TLC is 10 μm, the transmittance T is less than or equal to 1% when a voltage greater than or equal to 5 V is applied. In a case where the thickness TLC is 20 μm, the transmittance T is less than or equal to 1% when a voltage greater than or equal to 4 V is applied.

Thus, the dimming panel 300 in which the thickness TLC is greater than or equal to 5 μm and less than or equal to 20 μm can independently and sufficiently absorb linearly polarized illumination light which passed through the polarizer. It should be noted that, when the thickness TLC is 20 μm, the transmittance in an off state (the applied voltage E being 0 V) is less than or equal to 30%. For this reason, to realize a transmittance T which is less than or equal to 1% in an on state while assuring the transparency of an off state, the thickness TLC should be preferably 10 μm+2 μm.

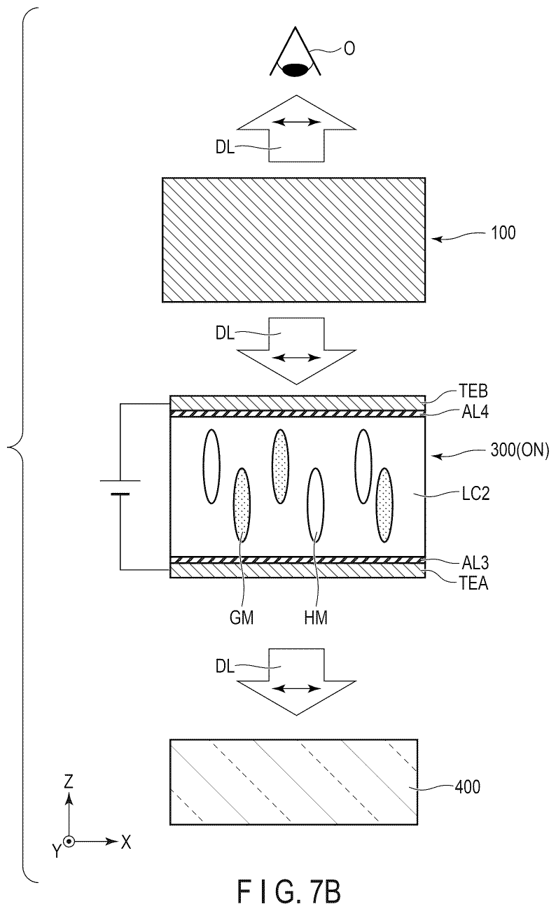

FIG. 9 is a diagram for explaining the matrix driving of the dimming panel 300.

The dimming area 300A has a plurality of segments SG arrayed in matrix in the first direction X and the second direction Y. As described above, each segment SG may be configured as the intersection of the first and second strip electrodes, or may be configured as an area in which a segment electrode electrically connected to an active element faces a sheet electrode. In this manner, each segment SG is configured to individually drive the guest-host liquid crystal of the liquid crystal layer LC2.

The dimming panel 300 is driven such that the absorption axis AA is formed when an image is displayed on the display panel 100, and such that no absorption axis is formed and a high transparency is imparted in a state where no image is displayed on the display panel 100. Further, by applying matrix driving to the dimming panel 300, the absorption axis AA can be formed in only segments which overlap the image displayed in the display panel 100.

In the example shown in the figure, four segments SG are arranged in the first direction X, and five segments are arranged in the second direction Y (five rows and four columns). Of the segments SG, the absorption axis AA is formed in the segments SG of the two rows and four columns of the upper side, and no absorption axis is formed in the segments of the three rows and four columns of the lower side.

Since the absorption axis AA is formed in only the segments SG which overlap the image, the visibility of the image can be improved, and further, the background can be easily observed in the other area.

The application examples of the display device 1 of the embodiment are explained below.

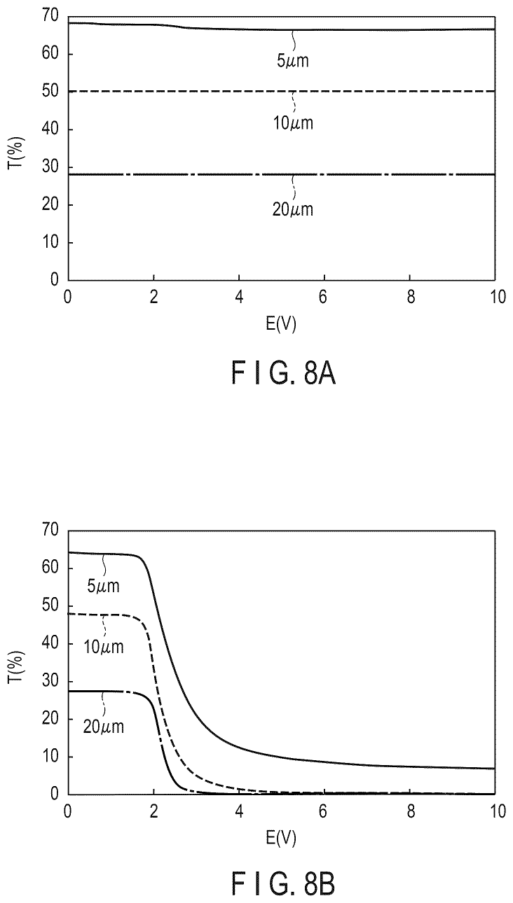

FIG. 10 is a diagram for explaining application example 1.

The user U is the driver or a fellow passenger of a vehicle. The display panel 100 faces the user U and is provided in, for example, the dashboard of the vehicle. The glass member 400 is the windshield of the vehicle. The dimming panel 300 is located between the display panel 100 and the glass member 400. In the example shown in the figure, the dimming panel 300 is attached to the display panel 100.

In this application example 1, when an image is displayed on the display panel 100, the absorption axis AA is formed in the dimming panel 300. By this configuration, the reflection of an image on the glass member 400 is prevented. The user U can observe the image of the display panel 100 without visually recognizing ghost images.

When no image is displayed on the display panel 100, the absorption axis AA is not formed in the dimming panel 300. Therefore, the user U can observe the front side of the vehicle through the display panel 100, the dimming panel 300 and the glass member 400.

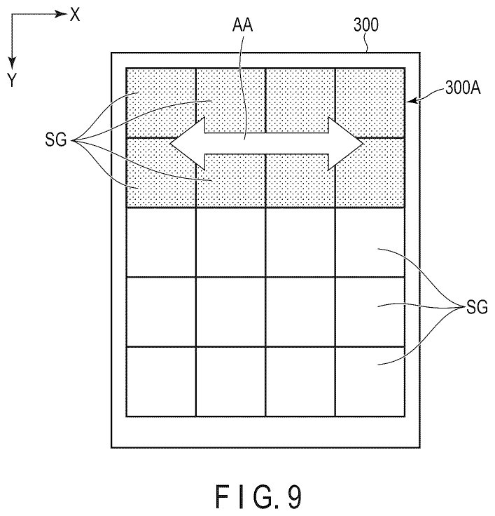

FIG. 11 is a diagram for explaining application example 2.

Application example 2 is different from application example 1 in respect that the dimming panel 300 is spaced apart from the display panel 100 and is attached to the glass member 400.

In this application example 2, effects similar to those of application example 1 are obtained.

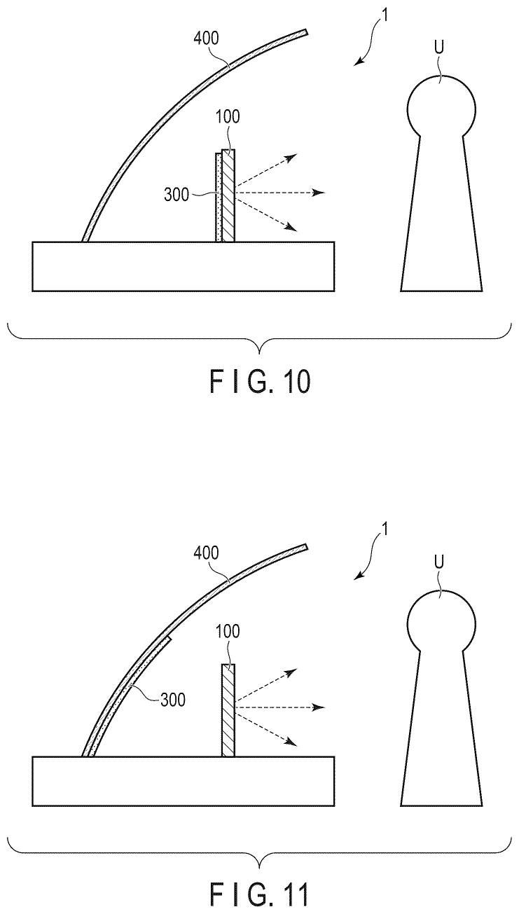

FIG. 12 is a diagram for explaining application example 3.

The glass member 400 is a windowpane. The glass member 400 and another windowpane GL are attached to a frame FL in a state where they face each other via an air layer AR, and constitute double glazing.

The display panel 100 is attached to the windowpane GL. The dimming panel 300 is attached to the glass member 400. The air layer AR is interposed between the display panel 100 and the dimming panel 300.

It should be noted that the display panel 100 may be attached to the windowpane GL in a state where the display panel 100 and the dimming panel 300 are attached to each other. In this case, the air layer AR is interposed between the dimming panel 300 and the glass member 400.

The dimming panel 300 may be attached to the glass member 400 in a state where the display panel 100 and the dimming panel 300 are attached to each other. In this case, the air layer AR is interposed between the display panel 100 and the windowpane GL.

In this display device 1, the observation position O is set on a side facing the windowpane GL.

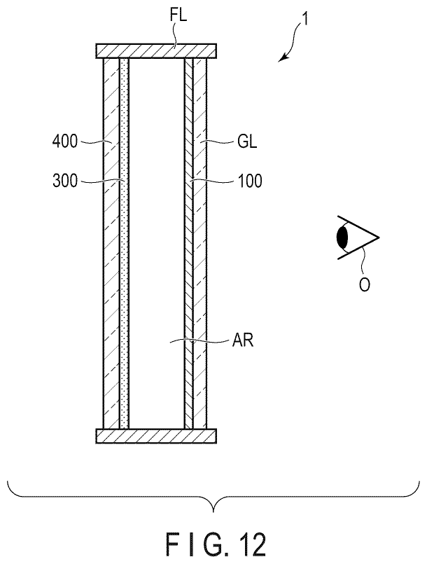

FIG. 13 is a diagram for explaining application example 4.

In application example 4, the display panel 100, the dimming panel 300 and the glass member 400 are attached to each other. Specifically, the glass member 400 faces the dimming panel 300 in the third direction Z and is attached to the transparent substrate 310 of the dimming panel 300 by the transparent adhesive layer AD1. The dimming panel 300 faces the display panel 100 in the third direction Z. The transparent substrate 320 of the dimming panel 300 is attached to the transparent substrate 110 of the display panel 100 by a transparent adhesive layer AD3. The transparent substrate 140 is attached to the transparent substrate 120 of the display panel 100 by the transparent adhesive layer AD2.

The light source unit 200 faces the side surface 140E of the transparent substrate 140 in the second direction Y.

Each of the glass member 400 and the transparent substrate 140 functions as a cover member. The transparent substrate 140 functions as a light guide which transmits the light emitted from the light source unit 200 parallel to the second direction Y.

The display area 100A overlaps the dimming area 300A in the third direction Z. The pixel electrodes PE and the common electrode CE overlap the transparent electrode TEA and the transparent electrode TEB in the third direction Z.

In this display device 1, the observation position o is set on a side facing the transparent substrate 140.

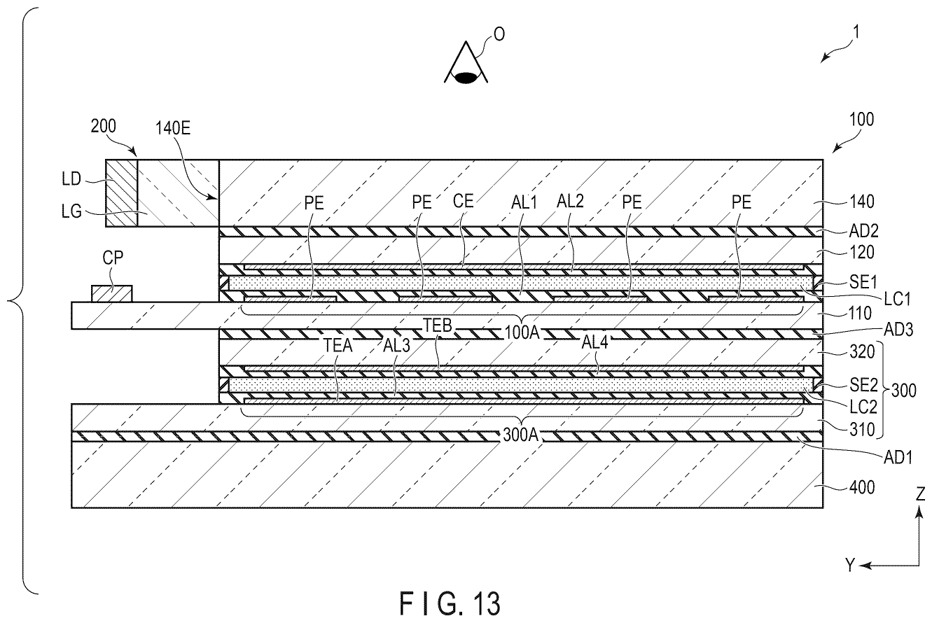

FIG. 14 is a diagram for explaining a configuration example of the control system of the display device 1.

The display device 1 comprises an illumination sensor 500 and a control unit 600 in addition to the display panel 100, the light source unit 200 and the dimming panel 300. The illumination sensor 500 is configured to measure the illuminance of the surrounding area of the display device 1.

The control unit 600 is configured to control each of the display panel 100, the light source unit 200, the dimming panel 300 and the illumination sensor 500.

For example, the control unit 600 drives each of the pixels of the display panel 100 and drives the light source unit 200 in synchronization with time points when the display panel 100 is driven. The control unit 600 drives the dimming panel 300 based on the illuminance measured by the illumination sensor 500. It should be noted that, as explained with reference to FIG. 9, the control unit 600 can perform driving such that the absorption axis AA is formed in, of the segments SG of the dimming panel 300, the segments SG which overlap the image displayed on the display panel 100.

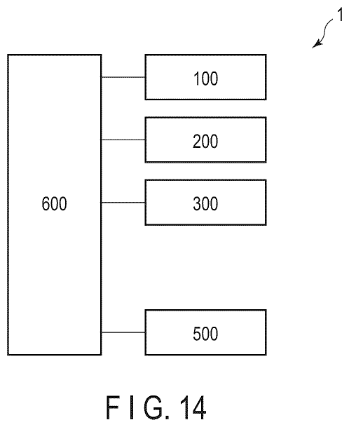

FIG. 15 is a diagram for explaining an example of the control of a vertical alignment dimming panel 300.

First, the control unit 600 measures the illuminance by controlling the illumination sensor 500 (step ST1). Subsequently, the control unit 600 determines whether or not the measured illuminance LX is less than or equal to a predetermined threshold LX_th (step ST2).

Based on determination in which the illuminance LX is less than or equal to the predetermined threshold LX_th (YES in step ST2), the control unit 600 sets the dimming panel 300 so as to be in an on state (step ST3). In other words, the control unit 600 applies voltage to each of the transparent electrode TEA and the transparent electrode TEB. In this manner, voltage is applied to the liquid crystal layer LC2, and the guest-host liquid crystal is driven. In the liquid crystal layer LC2, the host molecules HM and the guest molecules GM are horizontally aligned, and the absorption axis AA is formed in the dimming panel 300. This configuration prevents the image displayed on the display panel 100 from being reflected on the glass member 400 in dark places.

In the meantime, based on determination in which the illuminance LX is greater than the predetermined threshold LX_th (NO in step ST2), the control unit 600 sets the dimming panel 300 so as to be in an off state (step ST4). In other words, the control unit 600 does not apply voltage to the transparent electrode TEA or the transparent electrode TEB. In the liquid crystal layer LC2, the host molecules HM and the guest molecules GM are vertically aligned, and the absorption axis AA is not formed. Therefore, in bright places, the background can be observed through the dimming panel 300 and the glass member 400.

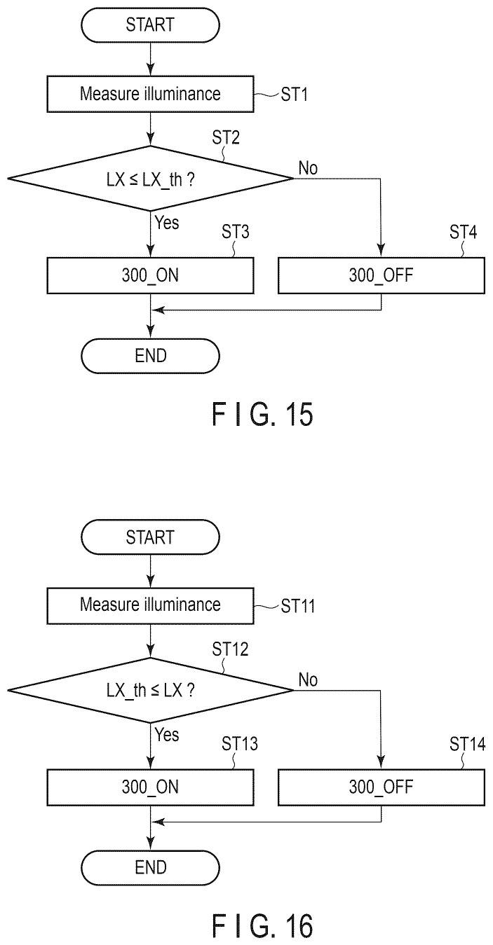

FIG. 16 is a diagram for explaining an example of the control of a horizontal alignment dimming panel 300.

First, the control unit 600 measures the illuminance by controlling the illumination sensor 500 (step ST11). Subsequently, the control unit 600 determines whether or not the measured illuminance LX is greater than or equal to a predetermined threshold LX_th (step ST12).

Based on determination in which the illuminance LX is greater than or equal to the predetermined threshold LX_th (YES in step ST12), the control unit 600 sets the dimming panel 300 so as to be in an on state (step ST13). In other words, the control unit 600 applies voltage to each of the transparent electrode TEA and the transparent electrode TEB. In this manner, voltage is applied to the liquid crystal layer LC2, and the guest-host liquid crystal is driven. In the liquid crystal layer LC2, the host molecules HM and the guest molecules GM are vertically aligned, and the absorption axis AA is not formed. Therefore, in bright places, the background can be observed through the dimming panel 300 and the glass member 400.

In the meantime, based on determination in which the illuminance LX is less than the predetermined threshold LX_th (NO in step ST12), the control unit 600 sets the dimming panel 300 so as to be in an off state (step ST14). In other words, the control unit 600 does not apply voltage to the transparent electrode TEA or the transparent electrode TEB. In the liquid crystal layer LC2, the host molecules HM and the guest molecules GM are horizontally aligned, and the absorption axis AA is formed. This configuration prevents the image displayed on the display panel 100 from being reflected on the glass member 400 in dark places.

In the embodiment described above, for example, the transparent substrate 110 corresponds to the first transparent substrate. The transparent substrate 120 corresponds to the second transparent substrate. The transparent substrate 310 corresponds to the third transparent substrate. The transparent substrate 320 corresponds to the fourth transparent substrate. The alignment film AL1 corresponds to the first alignment film. The alignment film AL2 corresponds to the second alignment film. The alignment film AL3 corresponds to the third alignment film. The alignment film AL4 corresponds to the fourth alignment film. The liquid crystal layer LC1 corresponds to the first liquid crystal layer. The liquid crystal layer LC2 corresponds to the second liquid crystal layer.

In the embodiment described above, a case where the back plate of the display device 1 is the glass member 400 is explained. However, the configuration is not limited to this example. For example, the back plate may be a transparent member which is different from a glass member or may be an opaque member such as a screen or whiteboard. In place of the back plate, an object may be provided.

As explained above, the present embodiment can provide a display device such that the display quality can be improved.

All of the display devices that can be implemented by a person of ordinary skill in the art through arbitrary design changes to the display device described above as each embodiment of the present invention come within the scope of the present invention as long as they are in keeping with the spirit of the present invention.

Various modification examples which may be conceived by a person of ordinary skill in the art in the scope of the idea of the present invention will also fall within the scope of the invention. For example, even if a person of ordinary skill in the art arbitrarily modifies the above embodiments by adding or deleting a structural element or changing the design of a structural element, or by adding or omitting a step or changing the condition of a step, all of the modifications fall within the scope of the present invention as long as they are in keeping with the spirit of the invention.

Further, other effects which may be obtained from the above embodiments and are self-explanatory from the descriptions of the specification or can be arbitrarily conceived by a person of ordinary skill in the art are considered as the effects of the present invention as a matter of course.

What is claimed is:

1. A display device comprising:
a display panel comprising a polymer dispersed liquid crystal containing a polymer and a liquid crystal molecule in a display area which displays an image;
a light source unit provided along an edge portion of the display panel;
a glass member located on a side opposite to an observation position of the display panel; and
a dimming panel located between the display panel and the glass member and comprising a guest-host liquid crystal in a dimming area which overlaps the display area, wherein
an initial alignment direction of the liquid crystal molecule in the display panel is parallel to an absorption axis in the dimming panel.

2. The display device of claim 1, wherein
the display panel comprises:
a first transparent substrate;
a second transparent substrate;
a first liquid crystal layer which is located between the first transparent substrate and the second transparent substrate and contains the polymer dispersed liquid crystal;
a first alignment film located between the first transparent substrate and the first liquid crystal layer; and
a second alignment film located between the second transparent substrate and the first liquid crystal layer,
the dimming panel comprises:
a third transparent substrate;
a fourth transparent substrate;
a second liquid crystal layer which is located between the third transparent substrate and the fourth transparent substrate and contains the guest-host liquid crystal;
a third alignment film located between the third transparent substrate and the second liquid crystal layer; and
a fourth alignment film located between the fourth transparent substrate and the second liquid crystal layer, and
alignment treatment directions of the first alignment film, the second alignment film, the third alignment film and the fourth alignment film are parallel to each other.

3. The display device of claim 2, wherein
the display panel further comprises:
a scanning line;
a signal line which intersects with the scanning line;
a switching element electrically connected to the scanning line and the signal line; and
a pixel electrode electrically connected to the switching element, and
the alignment treatment direction of the first alignment film is parallel to the scanning line.

4. The display device of claim 3, wherein
the polymer is formed into a streaky shape which extends along the scanning line.

5. The display device of claim 2, wherein
the guest-host liquid crystal has a a dichroic dye molecule as a guest molecule, and a liquid crystal molecule having a negative dielectric anisotropy as a host molecule, and
each of the third alignment film and the fourth alignment film is a vertical alignment film.

6. The display device of claim 5, further comprising:
an illumination sensor; and
a control unit which performs control such that voltage is applied to the second liquid crystal layer when illuminance measured by the illumination sensor is less than or equal to a predetermined threshold.

7. The display device of claim 2, wherein
the guest-host liquid crystal has a dichroic dye molecule as a guest molecule, and a liquid crystal molecule having a positive dielectric anisotropy as a host molecule, and
each of the third alignment film and the fourth alignment film is a horizontal alignment film.

8. The display device of claim 7, further comprising:
an illumination sensor; and
a control unit which performs control such that voltage is applied to the second liquid crystal layer when illuminance measured by the illumination sensor is greater than or equal to a predetermined threshold.

9. The display device of claim 2, wherein
a thickness of the second liquid crystal layer is greater than or equal to 5 μm and less than or equal to 20 μm.

10. The display device of claim 2, wherein
a thickness of the second liquid crystal layer is 10 μm±2 μm.

11. The display device of claim 1, wherein
the dimming area has a plurality of segments arranged in matrix, and
each of the segments is configured to individually drive the guest-host liquid crystal.

12. The display device of claim 1, wherein
the display panel and the dimming panel are attached to each other.

13. The display device of claim 1, wherein
the display panel faces the dimming panel via an air layer.

14. The display device of claim 1, wherein
the glass member is a windshield of a vehicle.

15. The display device of claim 1, wherein
the glass member is a windowpane.
